(19) United States
(12) Patent Application Publication
(10) Pub. No.: US 2023/0241857 A1
(43) Pub. Date: Aug. 3, 2023

(54) Film transportation plate and film transportation system

(71) Applicant: Harro Hoefliger Verpackungsmaschinen GmbH, Allmersbach im Tal (DE)

(72) Inventors: Andreas Thienst, Allmersbach im Tal (DE); Daniel Birkhold, Allmersbach im Tal (DE)

(21) Appl. No.: 18/161,698

(22) Filed: Jan. 30, 2023

(30) Foreign Application Priority Data
Feb. 1, 2022 (EP) 22 154 626.0

(51) Int. Cl. B31B 70/02; B31B 70/00; B65H 20/16

(52) U.S. Cl. CPC B31B 70/022; B31B 70/002; B65H 20/16; B65H 2701/1752; B65H 2801/81

(57) ABSTRACT

The disclosure relates to a film transportation plate and a film transportation system for transporting a film web through processing stations of a film packaging machine. The film transportation plate has two opposite lateral edges and, therebetween, at least one mold impression for thermoforming the film web. Retainers for the film web are arranged on the two lateral edges. The retainers are each formed by a fixed clamping surface and at least one clamping jaw, which is movable relative to the clamping surface, for pressing the film web so as to clamp it against the clamping surface. The retainers also each have at least one retaining magnet for attracting the clamping jaw against the clamping surface, and an actuating extension for lifting the clamping jaw off the clamping surface. The film transportation system also includes actuating means which act on the actuating extensions of the clamping jaws.

### CROSS-REFERENCE TO RELATED APPLICATIONS

This application claims priority of European patent application no. 22 154 626.0, filed Feb. 1, 2022, the entire content of which is incorporated herein by reference.

### TECHNICAL FIELD

The disclosure relates to a film transportation plate and to a film transportation system having such a film transportation plate.

In a widely used embodiment, packaging units are frequently produced in that first of all films are thermoformed. A product is introduced into the resultant cavities, this being followed by sealing with a cover film. A double-layered film strip is produced, in which part-quantities of the product are delimited from one another. These part-quantities are finally separated in a cutting station.

In particular in the domestic sector, single doses of detergent or rinsing agent are packaged in the abovementioned manner via two webs of water-soluble film. For industrial mass production, packaging machines are used in continuous, non-cyclic operation, as are known for example from US 2021/0276754. In that case, a conveyor in the form of a chain runs continuously about a fixed machine frame, wherein the conveyor passes along a straight, horizontal path on the top processing side. Together with the conveyor, transportation plates with so-called format plates are continuously carried along in circulation. Synchronously with the movement of the format plates, a first film web is continuously fed and placed on the top side of the transportation plates and carried along with the latter from station to station. A plurality of mold impressions are formed in the format plates, the film web being thermoformed in the mold impressions following thermal plasticizing. The cavities that arise in the film web in this way remain supported by the mold impressions and are filled with the desired product in a subsequent filling station. In ongoing operation, a further film web is fed as a cover film and sealed, such that mutually separated single quantities of the product are produced in a cohesive sachet web. Finally, single packs are cut out of this sachet web.

A partial problem to be solved here is to fix the first film web to the transportation plates such it is retained reliably and yet can be deformed freely during thermoforming. To this end, retaining means for the film web are arranged on the two lateral edges of the transportation plates, the retaining means being used to clamp the peripheral regions of the film web to the transportation plates, while the central region of the film web rests loosely and can be thermoformed. The lateral clamping ensures uniform plastic deformation of the film web during thermoforming, without the film edges being pulled inward. As a rule, the clamping takes place via two round belts that circulate on both sides of the transportation plates and are pressed, together with the respective peripheral region of the film web, into lateral belt receptacles of the transportation plates. In order that the film web can be clamped securely, the cross section of the round belt has to be wrapped at least to an extent of 180° by the film web. To achieve this, of the available film width, a considerable proportion has to be reserved for the clamping, and this cannot be used for the actual process of thermoforming and packaging. The effective usable width of the film web is accordingly reduced, this being accompanied by associated waste generation and with associated costs.

Furthermore, in the case of the round belts that are used, certain operating faults cannot be ruled out. The belts tend to stretch, and this can result in them jumping out of the belt guide. The stretching also entails a reduction in the retaining force, this resulting in faults in particular during thermoforming. It is even possible for a belt to tear.

### SUMMARY

It is an object of the disclosure to provide a film transportation plate such that improved lateral clamping of the film web is possible.

This object is, for example, achieved by a film transportation plate for transporting a film web through a plurality of processing stations of a film packaging machine, wherein the film transportation plate includes: a plate body having a first lateral edge and a second lateral edge disposed opposite to the first lateral edge; the plate body defining at least one mold impression for thermoforming the film web between the first lateral edge and the second lateral edge; a first retainer for the film web arranged at the first lateral edge; a second retainer for the film web arranged at the second lateral edge; the first retainer being formed by a first fixed clamping surface and at least one first clamping jaw; the second retainer being formed by a second fixed clamping surface and at least one second clamping jaw; the at least one first clamping jaw being configured to be moveable relative to the first clamping surface for pressing the film web so as to clamp the film web against the first clamping surface; the at least one second clamping jaw being configured to be moveable relative to the second clamping surface for pressing the film web so as to clamp the film web against the second clamping surface; the first retainer including at least one first retaining magnet configured to attract the at least one first clamping jaw against the first clamping surface and a first actuating extension for lifting the first clamping jaw off the at least one first clamping surface; and, the second retainer including at least one second retaining magnet configured to attract the at least one second clamping jaw against the second clamping surface and a second actuating extension for lifting the at least one second clamping jaw off the second clamping surface.

It is a further object of the disclosure to provide a film transportation system which allows edge holding of the film web with improved operational reliability.

This object is, for example achieved by a film transportation system for transporting a film web through processing stations of a film packaging machine. The film transportation system includes: a plurality of film transportation plates configured to be moved in circulation; each of the film transportation plates having a first lateral edge and a second lateral edge disposed opposite to the first lateral edge; each of the film transportation plates defining at least one mold impression for thermoforming the film web between the first lateral edge and the second lateral edge; each of the film transportation plates having a first retainer for the film web arranged at the first lateral edge and a second retainer for the film web arranged at the second lateral edge; the first retainers each being formed by a first fixed clamping surface and at least one first clamping jaw; the second retainers each being formed by a second fixed clamping surface and at least one second clamping jaw; the at least one first clamping jaw of each of the film transportation plates being configured to be moveable relative to the first clamping surface for pressing the film web so as to clamp the film web against the second clamping surface; the at least one second clamping jaw each of the film transportation plates being configured to be moveable relative to the second clamping surface for pressing the film web so as to clamp the film web against the first clamping surface; each of the first retainers including at least one first retaining magnet configured to attract the at least one first clamping jaw against the first clamping surface and a first actuating extension for lifting the at least one first clamping jaw off the first clamping surface; each of the second retainers including at least one second retaining magnet configured to attract the at least one second clamping jaw against the second clamping surface and a second actuating extension for lifting the at least one second clamping jaw off the second clamping surface; and, a fixed actuator configured to act on the first and the second actuating extensions.

The disclosure provides that the retainers or retaining means on the two lateral edges of the film transportation plate are each formed by a fixed clamping surface and at least one movable clamping jaw for pressing the film web so as to clamp it against the clamping surface. In this case, the retaining means also each have at least one retaining magnet for attracting the clamping jaw against the clamping surface, and an actuating extension for lifting the clamping jaw off the clamping surface. The film transportation system, which is likewise according to the disclosure, additionally includes fixed actuating means, that is, ones that do not circulate with the film transportation plates, which act on the actuating extensions of the clamping jaws.

In conjunction with the magnetic retaining force, the clamping jaws allow reliable holding of the film web on an in particular planar clamping surface, without material-intensive wrapping of a belt cross section being necessary. For secure film fixing, only a very narrow clamping region is required, in which a likewise narrow peripheral strip of the film web is retained. Thus, a greater proportion of the width of the film web is available for forming packaging cavities. More freedoms are created in the geometric configuration and distribution of the cavities. The achievable increase in the output quantity results in a proportional reduction in the machine and operating costs with regard to the individual products. The reduced peripheral strips bring about less film waste. The mechanism of the clamping jaws is more reliable with the creation of fewer faults. Furthermore, the achievable retaining forces are greater with an increased uniformity of the force distribution compared with a round belt.

The clamping jaws can be opened and closed in a linear movement. In an embodiment, the clamping jaws are mounted so as to be pivotable about pivot axes, wherein the pivot axes are parallel to the lateral edges of the film transportation plate. This results, with a small overall volume, in a precise, play-free and simple movement mechanism, which applies clamping forces without fault and also releases them again as required.

It may be expedient to configure the actuating extension as a mandrel or the like and to guide it in a sliding manner. Preferably, the actuating roller is provided with a run-on roller. As a result, as a result of a rolling movement, high actuating forces can be introduced with little wear into the moved clamping jaws.

In an embodiment of the disclosure, a plurality of and in particular four clamping jaws are arranged on each lateral edge of an individual film transportation plate. The clamping jaws that are formed in this way and are as narrow as possible ensure that only a small region covered by few clamping jaws has to be opened in order to apply the film web to the plates. As a result, there is only a small region in which the film web is free and unfixed.

It may be advantageous to arrange one or more retaining magnets on the clamping jaws. Preferably, however, the at least one retaining magnet is positioned in the clamping surface. In this way, the individual clamping jaws can be configured in a simple and lightweight manner such that they can be opened and closed again at a high cycle rate without mechanical considerations.

In an embodiment, suction openings for drawing the film web against the clamping surface are formed in the clamping surface. It is thus possible, where a negative pressure is available along the movement path of the transportation plates, for the retaining force at the edges of the film web to be significantly increased, such that it is not just the magnetic force that needs to be used for fixing. In particular in the region of the thermoforming station, where, as a result of the thermoforming operation, the highest forces act on the film, highly loadable film fixing can be achieved. However, even in the subsequent stations, for example in the filling station, where an admittedly low, but still present negative pressure acts on the film web, it is possible for the retaining force to be increased via the suction openings.

In addition, it may also be expedient for each clamping jaw to be assigned at least one closing spring, wherein the clamping jaw is pressed spring-elastically against the clamping surface via the closing spring. The closing springs not only increase the contact pressure and thus the retaining force. They can also bring about automatic closing of the clamping jaws from their completely open position, without a separate closing drive being absolutely necessary.

Various concepts come into question as actuating means of the clamping jaws.

Preferably, the actuators or actuating means can be in the form of a slotted guide which guides the actuating extensions, wherein the slotted guide includes at least one opening portion that lifts the clamping jaw off the clamping surface. The slotted guide thus acts with its opening portion on the actuating extension running thereon such that the clamping jaw is lifted or pivoted up counter to the holding force of the retaining magnet and possibly also counter to the preloading force of the closing spring. The subsequent closing of the clamping jaw can then be brought about without the slotted guide being influenced by the closing spring. Alternatively or additionally, an embodiment provides that the slotted guide includes a closing portion that guides the clamping jaw onto the clamping surface. This then brings about—with or without a closing spring—positively controlled closure of the clamping jaw. Overall, a reliable actuating mechanism with a simple structural configuration has been found.

### BRIEF DESCRIPTION OF DRAWINGS

The invention will now be described with reference to the drawings wherein:

FIG. 1 shows a lateral detail illustration of a packaging machine, embodied according to the disclosure, having film transportation plates that are moved continuously in circulation and having molding, filling and sealing stations that are carried along cyclically;

FIG. 2 shows a perspective illustration of individual parts of a film transportation plate according to FIG. 1 with clamping jaws that are arranged at the lateral edges thereof and are open here;

FIG. 3 shows an enlarged detail illustration of a peripheral region of the film transportation plate according to FIG. 2 with a clamping surface, with retaining magnets and suction openings in the clamping surface, and with an individual clamping jaw;

FIG. 4 shows a sectional illustration of the arrangement according to FIG. 3 with a closing spring acting on the clamping jaw in the closing direction;

FIG. 5 shows the arrangement according to FIG. 2 with closed clamping jaws;

FIG. 6 shows a perspective functional illustration of the film transportation plate according to FIGS. 2 to 5 with closed clamping jaws on running into an arrangement of slotted guides for clamping jaw actuation;

FIG. 7 shows the arrangement according to FIG. 6 with clamping jaws opened by the slotted guides; and,

FIG. 8 shows the arrangement according to FIGS. 6 and 7 on running out of the slotted guides and with closing clamping jaws.

### DETAILED DESCRIPTION

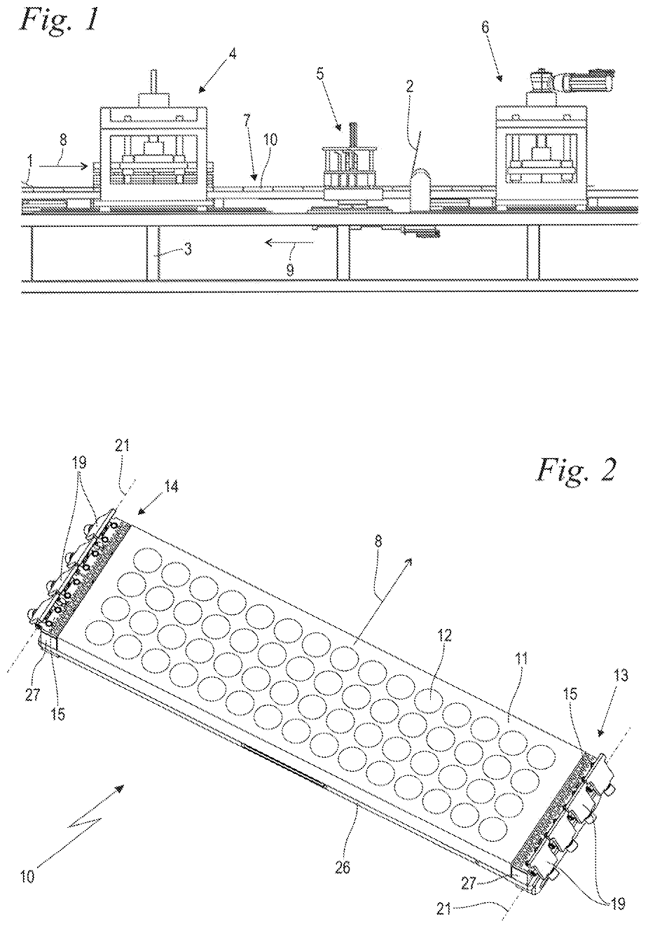

FIG. 1 shows a side view of a detail of a packaging machine according to the disclosure for producing filled sachets. To this end, the packaging machine includes a machine frame 3, a molding station 4, a filling station 5 and a sealing station 6. A film web 1 is fed to the packaging machine and thermoformed in the molding station 4, such that cavities are formed in the film web 1. These cavities are filled with a product in the filling station 5. Following this, a cover film 2 is supplied and sealed on the film web 1 in the sealing station 6, wherein the filled cavities are closed. In a cutting station that is not illustrated, the film unit formed in such a way is separated into film sachets. In the embodiment, the film web 1 and the cover film 2 are water-soluble films, specifically PVOH films, between which a detergent or cleaning agent is packaged. Film sachets produced in this way are placed for example in a dishwasher. Therein, the film material dissolves on contact with water and releases the rinsing agent it contains. The same applies, mutatis mutandis, for the use of such a film sachet in a washing machine.

In addition to the machine frame 3 mounted in a fixed position, the packaging machine includes a continuously driven conveyor 7. The conveyor 7 is formed by film transportation plates 10 which are connected together in an articulated and chain-like manner and on which format plates 11 (FIG. 2), described in more detail below, having mold impressions 12 are mounted. The latter are driven continuously, together with the conveyor 3, and in circulation about the machine frame 3, wherein, for the actual production process of the sachets, they move on an upper horizontal path in the direction of an arrow 8 and, after corresponding deflection, are subsequently returned in the lower region of the machine frame 3 in the direction of an arrow 9. The endless film web 1 is likewise fed continuously and placed from above on the conveyor 7 with the film transportation plates 10. Between the filling station 5 and the sealing station 6, the cover film 2 is subsequently also fed continuously and placed from above on the top side of the film web 1. The film web 1 and the cover film 2 are moved in the placed state synchronously and continuously together with the conveyor 7 in the direction of the arrow 8.

FIG. 2 shows a perspective illustration of individual parts of an individual film transportation plate 10 according to FIG. 1, wherein, for orientation purposes, the arrow 8 for the direction of movement in the packaging machine according to FIG. 1 has been included. The film transportation plate 10 includes a base plate 26, on which the format plate 11, already mentioned above, with a particular number of mold impressions 12 has been placed and fastened. Lateral edges 13, 14 of the film transportation plate are laterally opposite one another with regard to the direction of movement along the arrow 8 and extend parallel thereto. In the region of the lateral edges 13, 14, the format plate 11 is edged laterally by molded parts 27, on the top side of which planar clamping surfaces 15 are formed. The clamping surfaces 15 are flush-mounted with the surface of the format plate 11.

At the two lateral edges 13, 14, the film transportation plate 10 is provided in each case with at least one clamping jaw 19. In the embodiment shown, the film transportation plate 10 has, at the two lateral edges 13, 14, a plurality of, here in each case four, clamping jaws 19. The clamping jaws 19 are movable relative to the clamping surfaces 15 and are illustrated in the open state in the present case. To this end, the clamping surfaces 15 are formed fixedly at the lateral edges 13, 14, while the clamping jaws 19 are pivotable about pivot axes 21 extending parallel to the direction of movement 8. The fixed configuration of the clamping surfaces 15 means that they do not carry out any relative movement with respect to the film transportation plate 10, and only undergo a movement along the arrow 8 together therewith. However, it may also be expedient for the clamping surfaces 15 to be embodied in a movable manner. What is most important is that a relative movement between the clamping jaws 19 and clamping surfaces 15 can take place. Additionally or alternatively to the abovementioned pivotability of the clamping jaws, movability in translation may also be expedient.

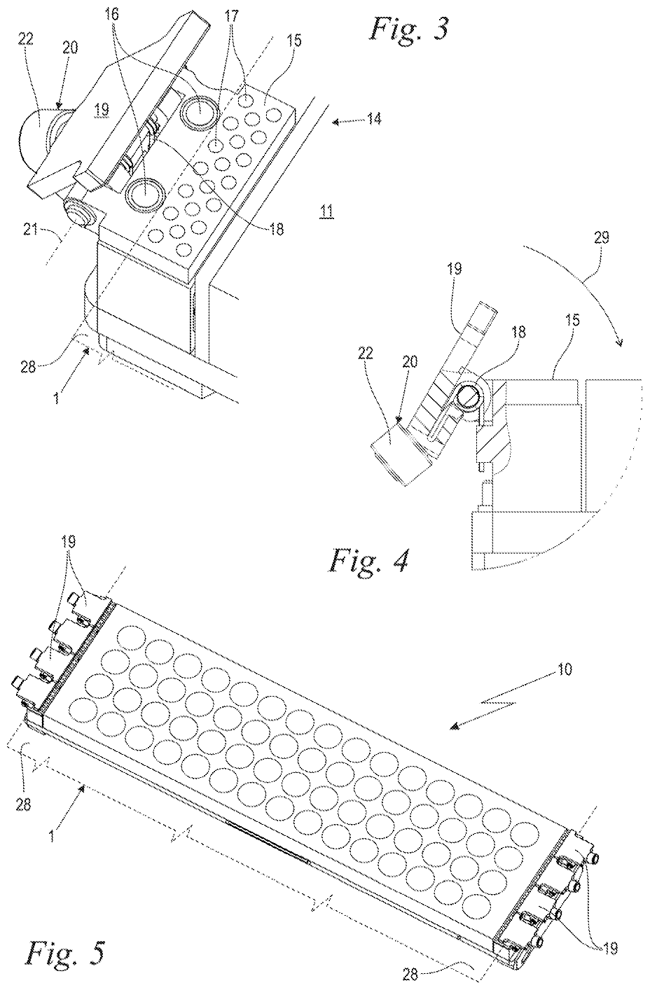

FIG. 3 shows an enlarged detail illustration of a peripheral portion of the film transportation plate 10 according to FIG. 2 in the region of an individual clamping jaw 19 and of the associated portion of the clamping surface 15. Integrated in the clamping surface 15 is at least one retaining magnet 16 for attracting the clamping jaw 19 against the clamping surface 15. In the embodiment shown, there are in each case two retaining magnets 16 for each clamping jaw 19. Furthermore, suction openings 17 have been introduced into the clamping surface 15 in the peripheral region directly adjoining the format plate 11, which suction openings 17 can be connected to a suction source as required. Optionally, a closing spring 18 is additionally also provided, which, in accordance with the additional sectional illustration according to FIG. 4, is in the form of a leg spring and acts on the clamping jaw 19 such that the latter is preloaded spring-elastically in the direction of an arrow 29 toward the clamping surface 15 and is pressed against the latter. Finally, it is also apparent from viewing FIGS. 3 and 4 together that each clamping jaw 19 is provided with an actuating extension 20 which protrudes laterally beyond the respective lateral edge 13, 14 and is provided for actuating the clamping jaw 19. Each actuating extension 20 carries a respective run-on roller 22.

FIG. 5 shows the arrangement according to FIG. 2 with closed clamping jaws 19, which rest here on the associated clamping surfaces 15 with peripheral portions 28 of the film web 1, which is only indicated, interposed.

On viewing FIGS. 3 and 5 together, the operating principle of the film clamping becomes apparent as follows: With the clamping jaws 19 open according to FIGS. 2 and 3, the film web 1 can be placed on the film transportation plate 10, wherein it covers the format plate 11 with the mold impressions 12. The peripheral portions 28 of the film web 1 come to rest on both sides on the clamping surfaces 15. Subsequently, the clamping jaws 19 are closed according to FIG. 5, wherein they clamp the peripheral portions 28 of the film web 1 between themselves and the clamping surfaces 15. The clamping force is generated by the retaining magnets 16 and can optionally be supplemented by the closing springs. Overall, retaining means are formed as a result, via which the film web 1 is fixed reliably to the respective film transportation plate 10 and is transported together with the latter through the various processing stations 4, 5, 6 (FIG. 1). When there is an increased demand for retaining force, for example in the region of the molding station 4 (FIG. 1) in which the film web is exposed to the forces of the thermoforming negative pressure, negative pressure is additionally applied to the suction openings 17 (FIG. 3). As a result of being drawn in by the suction openings 17, the peripheral portions 28 of the film web 1 are additionally pressed or sucked against the respective clamping surface, this contributing to the increase in the retaining force. The negative pressure provided at the clamping surfaces 15 by the suction openings 17 can also act proportionally on the clamping jaws 19 and thus contribute to increasing the closing force thereof.

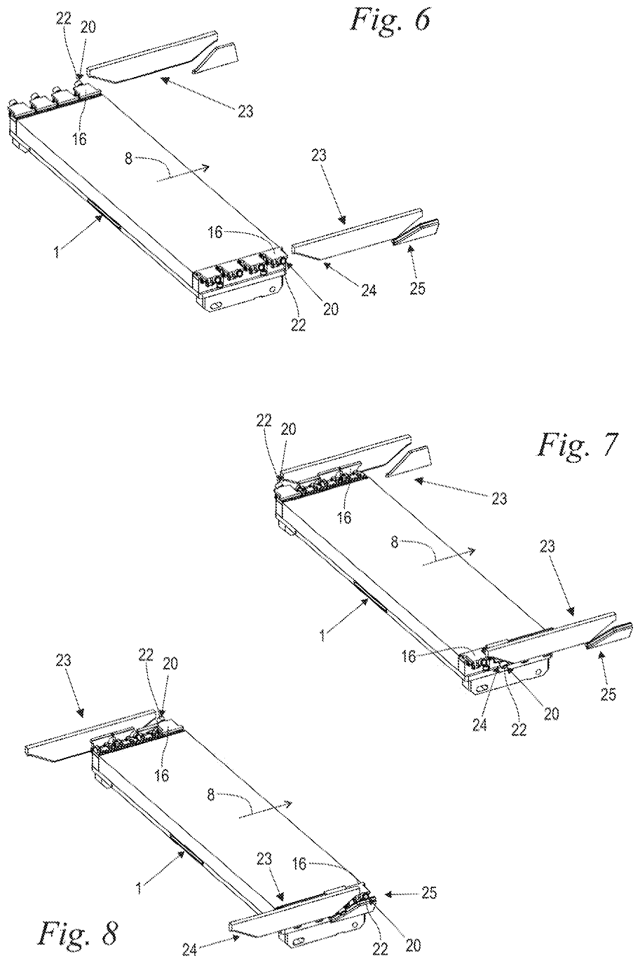

The kinematic actuation of the clamping jaws 19 is apparent from the phase images according to FIGS. 6 to 8, in which the film transportation plate 10 according to FIGS. 2 to 5 is illustrated in different phases of opening and closing. The film transportation plate 10 forms, for this purpose, together with fixed actuating means that act on the actuating extensions 20 of the clamping jaws 19, a film transportation system according to the disclosure, which is described in more detail in the following text.

A respective slotted guide 23 is fixedly mounted on the side of the machine frame 3 (FIG. 1), which, for greater clarity, is not illustrated in FIGS. 6 to 8. In other words, the slotted guides 23 are not moved together with the film transportation plates 10 in the direction of the arrow 8. As a result of the movement of the film transportation plates 10, the actuating extensions 20 of the clamping jaws 19 are successively introduced with their run-on rollers 22 into the slotted guides 23.

According to FIG. 6, the film transportation plate 10 is located just before it enters the slotted guides 23, which do not yet act on the actuating extensions 20 of the clamping jaws 19. Consequently, the clamping jaws 19 are in their closed rest state according to FIG. 5, in which they are pressed against the clamping surfaces 15 on account of the acting magnetic and spring forces. In contrast to FIG. 5, a film web 1 has not yet been introduced here.

In the following phase, shown in FIG. 7, the film transportation plate 10 has been transported forward in the direction of the arrow 8 to such an extent that the actuating extensions 20 have run with their run-on rollers 22 into the slotted guides 23 and are guided by the slotted guides 23. The run-on rollers 22 roll in the process on the surfaces of the slotted guides 23, follow the shape thereof and in this way generate a pivoting movement of the clamping jaws 19 that is described in particular in connection with FIG. 4. The slotted guides 23 each have at least one opening portion 24 and optionally also each have a closing portion 25. According to FIG. 7, via the run-on rollers 22 rolling thereon, the opening portion 24 presses the actuating extensions 20 downward, with the result that the clamping jaws 19 are pivoted upward counter to the arrow 29 (FIG. 4) and counter to the retaining forces generated by the retaining magnets 16 and the closing springs 18, and are thus opened. In this open state according to FIG. 7, the film web 1 according to FIGS. 1 and 3 can be introduced.

After this has taken place, the clamping jaws 19 are closed again in order to clamp and retain the film web 1 according to FIG. 5 at its peripheral portions 28. To this end, it may suffice for the film transportation plate 10 to pass with its actuating extensions 20 rearward out of the slotted guides 23, wherein the closing springs 18 then bring about the operation of closing according to FIG. 4. If the preloading force of the closing springs 18 is not sufficient for this, or if the optional closing springs are omitted, the closing portions 25, then provided, of the slotted guides 23 according to FIG. 8 are used. In this last phase image, the film transportation plate 10 has been transported forward in the direction of the arrow 8 to such an extent that the actuating extensions 20 have run with their run-on rollers 22 into the closing portions 25 of the slotted guides 23 and are lifted there on account of the rising contour profile to be encountered there. The lifting of the run-on rollers 22 brings about a closing pivoting movement of the clamping jaws 19, as is illustrated in FIG. 4 with an arrow 29. The closing movement is positively controlled by the closing portions 25 of the slotted guides 23 until the retaining magnets 16 and optionally also the suction openings 17 and/or the closing springs 18 exert their desired closing force. The previously introduced film web 1 is then retained as described above and in particular in accordance with the illustration according to FIG. 5.

After the packages have been completed and separated in the packaging machine according to FIG. 1, a further actuating apparatus according to FIGS. 6 to 8 can be used. Here, in succession, the clamping jaws 19 are opened 19, the rest of the film web 1 removed, and the clamping jaws 19 are closed again such that the above-described cycle can be begin again.

It is understood that the foregoing description is that of the preferred embodiments of the invention and that various changes and modifications may be made thereto without departing from the spirit and scope of the invention as defined in the appended claims.

1. A film transportation plate for transporting a film web through a plurality of processing stations of a film packaging machine, wherein the film transportation plate comprises:
a plate body having a first lateral edge and a second lateral edge disposed opposite to said first lateral edge;
said plate body defining at least one mold impression for thermoforming the film web between said first lateral edge and said second lateral edge;
a first retainer for the film web arranged at said first lateral edge;
a second retainer for the film web arranged at said second lateral edge;
said first retainer being formed by a first fixed clamping surface and at least one first clamping jaw;
said second retainer being formed by a second fixed clamping surface and at least one second clamping jaw;
said at least one first clamping jaw being configured to be moveable relative to said first clamping surface for pressing the film web so as to clamp the film web against the first clamping surface;
said at least one second clamping jaw being configured to be moveable relative to said second clamping surface for pressing the film web so as to clamp the film web against the second clamping surface;
said first retainer including at least one first retaining magnet configured to attract said at least one first clamping jaw against said first clamping surface and a first actuating extension for lifting said first clamping jaw off said at least one first clamping surface; and,
said second retainer including at least one second retaining magnet configured to attract said at least one second clamping jaw against said second clamping surface and a second actuating extension for lifting said at least one second clamping jaw off said second clamping surface.

2. The film transportation plate of claim 1, wherein said at least one first clamping jaw and said at least one second clamping jaw are mounted so as to be pivotable about pivot axes; and, said pivot axes are parallel to said first and second lateral edges of the film transportation plate.

3. The film transportation plate of claim 1, wherein said first actuating extension and said second actuating extension are each provided with a run-on roller.

4. The film transportation plate of claim 1, wherein a plurality of said first clamping jaws are arranged on said first lateral edge and a plurality of said second clamping jaws are arranged on said second lateral edge.

5. The film transportation plate of claim 1, wherein four of said first clamping jaws are arranged on said first lateral edge and four of said second clamping jaws are arranged on said second lateral edge.

6. The film transportation plate of claim 1, wherein said at least one first retaining magnet is positioned in said first clamping surface.

7. The film transportation plate of claim 1, wherein said first clamping surface defines a plurality of suction openings for drawing the film web against said first clamping surface.

8. The film transportation plate of claim 1, wherein said at least one first clamping jaw is assigned at least one first closing spring and said at least one first clamping jaw is configured to be pressed spring elastically against said first clamping surface via said first closing spring; and, said at least one second clamping jaw is assigned at least one second closing spring and said at least one second clamping jaw is configured to be pressed spring elastically against said second clamping surface via said second closing spring.

9. A film transportation system for transporting a film web through processing stations of a film packaging machine, the film transportation system comprising:
a plurality of film transportation plates configured to be moved in circulation;
each of said film transportation plates having a first lateral edge and a second lateral edge disposed opposite to said first lateral edge;
each of said film transportation plates defining at least one mold impression for thermoforming the film web between said first lateral edge and said second lateral edge;
each of said film transportation plates having a first retainer for the film web arranged at said first lateral edge and a second retainer for the film web arranged at said second lateral edge;
said first retainers each being formed by a first fixed clamping surface and at least one first clamping jaw;
said second retainers each being formed by a second fixed clamping surface and at least one second clamping jaw;
said at least one first clamping jaw of each of said film transportation plates being configured to be moveable relative to said first clamping surface for pressing the film web so as to clamp the film web against the second clamping surface;
said at least one second clamping jaw each of said film transportation plates being configured to be moveable relative to said second clamping surface for pressing the film web so as to clamp the film web against the first clamping surface;
each of said first retainers including at least one first retaining magnet configured to attract said at least one first clamping jaw against said first clamping surface and a first actuating extension for lifting said at least one first clamping jaw off said first clamping surface;
each of said second retainers including at least one second retaining magnet configured to attract said at least one second clamping jaw against said second clamping surface and a second actuating extension for lifting said at least one second clamping jaw off said second clamping surface; and,
a fixed actuator configured to act on said first and said second actuating extensions.

10. The film transportation system of claim 9, wherein said actuator is a slotted guide configured to guide said actuating extensions; and, said slotted guide includes at least one opening portion configured to lift said at least one first and second clamping jaws off said first and second clamping surfaces.

11. The film transportation system of claim 10, wherein said slotted guide includes a closing portion configured to guide said at least one first and said second clamping jaws onto corresponding ones of said first clamping surface and said second clamping surface.

12. A film transportation plate for transporting a film web through a plurality of processing stations of a film packaging machine, the film transportation plate comprising:
a film transportation plate body having two opposite lateral edges and, therebetween, at least one mold impression for thermoforming the film web;
retaining means for the film web arranged at each of the two lateral edges;
wherein said retaining means are each formed by a fixed clamping surface and at least one clamping jaw movable relative to said clamping surface for pressing the film web so as to clamp the film web against said clamping surface;
said retaining means also each have at least one retaining magnet configured to attract said at least one clamping jaw against said clamping surface; and,
said retaining means each further have an actuating extension configured to lift said at least one clamping jaw off said clamping surface.
